(19) United States
(12) Patent Application Publication
(10) Pub. No.: US 2013/0101700 A1
(43) Pub. Date: Apr. 25, 2013

(54) PROCESS FOR UPGRADING FRESH MEAT

(71) Applicants: Lucas Oechslin, Zurich (CH); Marco Tessaro, Zurich (CH)

(72) Inventors: Lucas Oechslin, Zurich (CH); Marco Tessaro, Zurich (CH)

(21) Appl. No.: 13/805,354

(22) PCT Filed: Jun. 19, 2011
(86) PCT No.: PCT/EP11/60175

§ 371 Date: Dec. 19, 2012

(30) Foreign Application Priority Data
Jun. 21, 2010 (CH) 00993/10
Oct. 8, 2010 (EP) 10186921.2
Apr. 23, 2011 (EP) 11163616.3

(51) Int. Cl. A23L 1/318

(52) U.S. Cl. CPC A23L 1/3185
USPC 426/56; 426/60

(57) ABSTRACT

The process for upgrading fresh meat is effected by adding the mold fungus Thamnidium elegans during the maturing of the meat, storing the meat within a temperature range between 0 and 8° C., storing the meat at a relative air humidity between 50% and 95%, and storing the meat for between 21 and 100 days.

The invention relates to a process for upgrading fresh meat in accordance with the preamble of claim 1.

### PRIOR ART

After slaughter, fresh meat is subjected to a so-called meat maturing or meat aging. The processes that take place during meat aging affect in particular the tenderness, the flavor, and the juiciness of the meat, hence these processes are decisive for the ultimately achieved meat quality.

Meat aging is a process that takes place inside the muscle fibers of the meat. Meat aging begins right after slaughtering, as the still warm meat is being cooled. Meat aging occurs in two phases:

In the first phase of meat aging, rigor mortis sets in in the initially soft and relaxed muscles. This happens because the blood supply and thus the oxygen supply to the muscles is cut off with slaughtering. Metabolism now takes place under anaerobic conditions. The carbohydrate glycogen in the muscles is converted to lactic acid and energy is stored in the form of ATP. In the living, contracted muscle, ATP acts as a “tenderizer”. ATP, which allows the muscle after contraction to become soft and relaxed again, can no longer be produced once the glycogen reserves are exhausted. The muscles now remain in a tense, rigid state characterized by maximum toughness and minimum water-binding capacity.

The processes essential to the ultimately achieved meat quality take place in the second phase of meat aging. In beef, for example, rigor mortis usually dissolves after about 24 to 30 hours. The lactic acid formed during the first phase causes the pH value of >7 during slaughtering to drop below 5.8. In the second phase, liberated proteolytic enzymes such as cathespins and calpains cause the muscle fiber structures (myofibrils) to break down, which gradually improves the tenderness of the meat. The resulting free amino acids are also important for the development of the flavor or for the savoriness of the meat. The water-binding capacity also increases during meat aging and thus may be affected by the aging process. Meat aging thus affects the tenderness, flavor, and juiciness of the meat.

Various processes for aging meat are known.

In so-called “wet aging”, after slaughtering the fresh meat is detached from the bone and vacuum-packed for aging. With this process water cannot evaporate from the meat, hence the meat loses essentially no weight during the aging, which is economically advantageous. After a specific storage period the meat is removed from the vacuum packaging and is ready for sale.

In so-called “dry aging”, the fresh meat is not detached from the bone and is not vacuum-packed, thus enabling a high-quality meat aging. The bones (which were not removed for storage) render the meat more flavorful. Dry aging has the disadvantage that the meat loses weight as a result of cold evaporation of the water contained in the meat. Dry aging has the additional disadvantage that the meat forms dried surfaces that need to be cut off, thus resulting in additional weight loss. Compared to wet aging, dry aging has the advantage that the meat has a better flavor due to the meat remaining on the bone and because the flavorings are concentrated in the meat due to the water loss.

Prior art methods therefore have disadvantages in terms of weight loss, flavorings, and tenderness of the meat.

U.S. Pat. No. 3,056,679 discloses a method for accelerating meat aging and for improving the flavor of the meat using the mold Thamnidium elegans, wherein the meat is aged for between 12 and 48 hours and at 4.4° C.

U.S. Pat. No. 3,128,191 discloses a method for accelerating meat aging and for improving the flavor of the meat using the mold Thamnidium elegans, wherein the meat is aged for between 1 and 10 days at temperatures between 1.7° C. and 4.4° C.

GB 875 339 discloses a method for accelerating meat aging and for improving the flavor of the meat using the mold Thamnidium elegans, wherein the meat is aged for 48 hours, wherein the temperature during the first 8 hours is raised from 1.7° C. to between 15.6° C. and 24.9° C., and wherein the meat is then matured for 32 hours at a temperature between 18.3° C. and 24.9° C., and wherein the meat is then cooled for 8 hours at a temperature between 0° C. and 1.7° C.

U.S. Pat. No. 2,816,836 discloses a method for accelerating meat aging and for improving the flavor of the meat using the mold Thamnidium elegans, wherein the meat is aged for 7 days at a temperature higher than 7.2° C. and less than 15.6° C.

The aim of all four of the aforementioned methods is to accelerate meat aging by using the mold Thamnidium elegans. Such methods are also known as fast aging processes. However, these methods have the disadvantage that the taste and the tenderness of the meat does not satisfy demanding meat connoisseurs.

### PRESENTATION OF THE INVENTION

The object of the invention is to propose an improved process for aging meat. This object is achieved with a method having the features of claim 1. Dependent claims 2 through 14 relate to other advantageous method steps.

The object is in particular achieved with a process for upgrading fresh meat, wherein the mold Thamnidium elegans is added during the aging of the meat, and wherein the meat is stored within a temperature range between 0 and 8° C., and wherein the meat is stored at a relative humidity between 50% and 98%, and wherein the meat is stored for between 21 and 100 days.

The meat is particularly advantageously stored within a temperature range between 1 and 5° C., at a relative humidity between 75% and 95%, and for between 28 to 45 days.

The meat is most advantageously stored at a temperature between 2 and 4° C., at a relative humidity between 85% and 98%, preferably between 90% and 98%, and for between 28 to 45 days.

The mold Thamnidium elegans is particularly advantageously applied to the surface of the meat at a spore density of at least 10⁹ spores per cm². Applying a higher spore density of at least 10¹² spores per cm², preferably between 10¹² spores per cm² and 10¹⁵ spores per cm², may also prove advantageous. The mold is usually applied within 3 days after slaughter, preferably within 2 days after slaughter. If need be the mold can be applied as late as 14 days after slaughtering. In order to prevent the growth of bacteria in particular and in order to achieve a sufficiently long time for the mold to act on the meat, preference is given to an application within 2 to 3 days after slaughtering.

The process of the invention has the advantage that the treated meat is especially tender and/or juicy and has an exceptionally pleasant and intense flavor hitherto unknown in this form.

Using the mold Thamnidium elegans to accelerate meat aging so that the meat is mature and ready for sale within 10 days is known from the prior art.

With the process of the invention, it was surprisingly discovered that with a hitherto unknown exceptionally long storage period of between 21 to 100 days and preferably of between 28 to 100 days, the mold Thamnidium elegans imparted a particularly pleasant and intense flavor and an extraordinary tenderness to the meat. Formerly a person skilled in the art only used the mold Thamnidium elegans to accelerate meat aging for at most 10 days. Formerly, however, a person skilled in the art was unable to perceive any benefit from using the mold Thamnidium elegans for more than 10 days. On the basis of his expert knowledge, a person skilled in the art was discouraged from considering a longer meat aging with the mold Thamnidium elegans because he was aware of several problems arising from longer storage time. Prolonging meat aging beyond 10 days poses a considerable risk of the meat spoiling, especially since bacteria reproduce exponentially over time such that with each additional day there is a considerable risk that the meat will spoil. A person skilled in the art would therefore not have considered the extraordinarily long period of meat aging of at least 21 days or more. Aging meat for more than 10 days also leads to water loss and to a dried surface or formation of a crust on the meat surface. This crust can no longer be used and thus constitutes a meat loss. The water loss also results in a weight loss. A person skilled in the art would also not have considered aging meat for more than 10 days for economic reasons, in order to avoid these losses.

The consequence of aging meat by using the mold Thamnidium elegans for at least 21 days is that the meat becomes thoroughly permeated with fungus or its mycelium. The result is an especially tender meat with an intense flavor.

In the meat maturing of the invention it is necessary to ensure that the meat does not spoil. Under standard conditions bacteria grow faster than the mold Thamnidium elegans. It is therefore necessary to select the meat aging process parameters and the use of the mold Thamnidium elegans such that the growth of the bacteria is inhibited and the growth of the mold is stimulated. In a particularly advantageous process the mold Thamnidium elegans is applied to the surface of the meat at a spore density of at least 10⁹ spores per cm². Preference is given to making this application within the first two to four days after slaughtering the animal. The antibacterial effect of the mold at this high concentration is especially effective in inhibiting the growth of the bacteria, wherein temperature and humidity are used such that they stimulate the growth of the mold and inhibit the growth and/or reproduction of the bacteria, thus ensuring that the meat will not spoil even with storage periods of between 21 or 28 and 100 days.

The mold Thamnidium elegans is advantageously applied in liquid form as a cell suspension of the fungus over as much of the surface of the meat as possible, with a spore density of preferably 10⁹ spores per cm² to 10¹⁵ spores per cm², advantageously with 10¹² spores per cm² to 10¹⁵ spores per cm² or also with 10⁹ spores per cm² to 10¹² spores per cm². A uniform application is particularly advantageous for inhibiting or preventing the growth of bacteria on the entire surface of the meat.

At the end of the storage period of at least 21 days, the meat is completely permeated with the mold Thamnidium elegans and has on its surface a crust that is completely covered with the mold. At the end of the storage period this crust is cut off and disposed of, and the meat is then ready for sale. Surprisingly it has been shown that the process of the invention is economically advantageous in spite of the resulting meat and weight loss, since consumers are willing to pay a substantially higher price for the exceptional quality of the meat upgraded by the process of the invention.

### BRIEF DESCRIPTION OF THE FIGURES

The figures used for clarification show:

FIG. 1 an internationally recognized meat classification scheme based on meat content and fat content;

FIG. 2 the different conformation (meat content) classes;

FIG. 3 the different fat classes;

FIG. 4 a graph of the change in firmness and flavor over time.

### MEANS OF IMPLEMENTING THE INVENTION

In the meat aging process of the invention, the fresh meat is stored in the open. In other words the fresh meat is not packaged, especially not vacuum-packed. The fresh meat can either be left on or detached from the bone. In order to achieve a particularly advantageous flavor, it is advantageous to leave the fresh meat on the bone. Additionally, the meat is brought into contact with the mold Thamnidium elegans. The meat aging process of the invention including a treatment with the aforementioned mold enhances the flavor and/or increases the tenderness and/or the juiciness of the meat. “The mold Thamnidium elegans” is understood to mean all natural strains and genetic mutations of the fungus.

In an illustrative process, the mold is brought into contact with the meat (veal, beef, lamb, horse, pork, etc.) at the beginning of the second meat aging phase, i.e., after rigor mortis of the muscle tissue has completely set in (1-2 days). The spores of the mold Thamnidium elegans are applied, for example, by brushing or by immersing the meat. Tamnidium elegans permeates the meat during the subsequent storage and with various proteases assists in breaking down the rigor mortis and the collagen. This leads to an improvement in tenderness. Additionally, Thamnidium elegans imparts a nutty flavor to the meat, which is greatly esteemed by connoisseurs and is considered a characteristic of ideally matured meat.

Inoculation of the meat with Thamnidium elegans can be performed in the manner described below:

An initial assessment of the mold colony is performed after culturing the mold on a malt extract solid medium at room temperature and for ca. 7 days. If the typical coloring indicative of spore formation is evident, the culture can be used for inoculating the meat. The actual inoculation takes place in the cold room right at the beginning of meat storage, i.e., preferably 1 to 3 days after the animal is slaughtered. With a standard brush, the fungus spores and hyphae are transferred from the solid medium culture and applied to the meat. The spore density applied to the surface of the meat is approximately 10⁹ spores per cm² to 10¹⁵ spores per cm². It is important to ensure that the spores are applied in a uniform manner over the entire surface. If need be, this procedure can be repeated during the first week at 2 and 4 day intervals. Briefly immersing the entire piece of meat in the fluid can also prove advantageous.

Even in a cold room with a high proportion of pieces of meat already overgrown with mold, allowing the fresh meat to be inoculated by the fungus spores circulating in the air is not sufficient. Even in this case the method described above is required in order to ensure a sufficiently high spore density on the meat surface.

Preference is given to using a high relative humidity during the meat aging. The meat will dry out too much if the relative humidity is too low. As far as humidity is concerned, however, it is also important to ensure that the latter is not too high, as otherwise water could settle out on the meat and cause a slime layer to form, wherein resides the disadvantage that this slime layer constitutes a nutrient substrate for undesired bacteria. The relative humidity used for meat aging is preferably within the range between 50% and 98%, particularly within the range between 75% and 85%, and most preferably within the range between 85% and 98%.

Storage takes place at a temperature of at least 0° C. so that Thamnidium elegans is able to grow sufficiently. Raising the temperature increases the risk of the meat being contaminated by undesired microorganisms. The advantageous temperature range for the storage of meat with Thamnidium elegans is between 0° C. and 8° C. and preferably between 2 and 4° C.

The storage period is another key process parameter. The period is selected such that rigor mortis is dissolved as completely as possible and Thamnidium elegans is able to permeate the meat completely and thus ensure homogeneous flavor distribution and also uniform collagen breakdown in the meat. The storage period is preferably within a range of between 14 and 100 days, and particularly within a range of between 21 or 28 and 50 days, particularly around 35 days.

In a particularly advantageous manner the meat is stored within a temperature range between 1 and 5° C., at a relative humidity between 75% and 95%, and for between 25 and 45 days. The meat is more advantageously stored at a temperature of around 3° C., at a relative humidity of around 85%, and for around 35 days. The meat is particularly advantageously stored at a temperature between 2 to 4° C., at a relative humidity between 85% and 98%, preferably between 90% and 98%, and for between 28 and 45 days.

The process is especially well-suited for treating beef. The meat of all cattle breeds is suitable, particularly the meat of Angus, Braunvieh, Simmenthal, Charolais, Hereford, Wagyu, or bison. However, the process is also suitable for treating veal, lamb, horsemeat, or pork.

In order to keep the meat from drying out during the long storage period, use is advantageously made of a meat with a relatively high fat content, as fat has the capacity to bind water. In addition use is advantageously made of a meat with a high meat content.

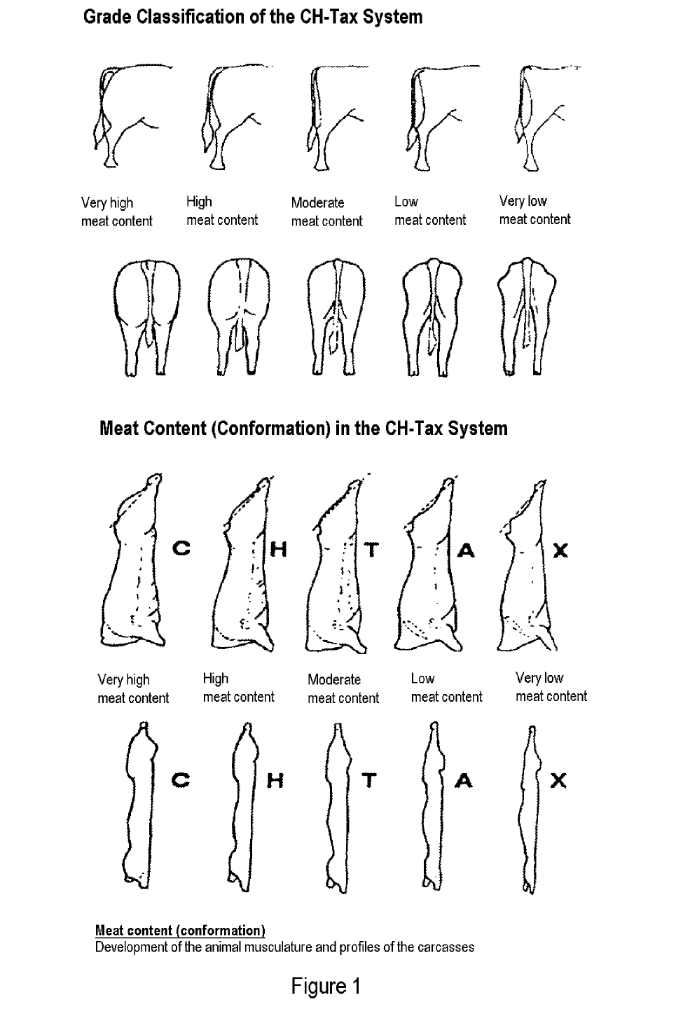

The characteristics of slaughtered meat are classified on the basis of an internationally recognized scheme based on conformation (meat content) and fat content. In Switzerland this classification scheme is known as the CH-tax system, according to which meat is classified as shown in FIGS. 1 through 3.

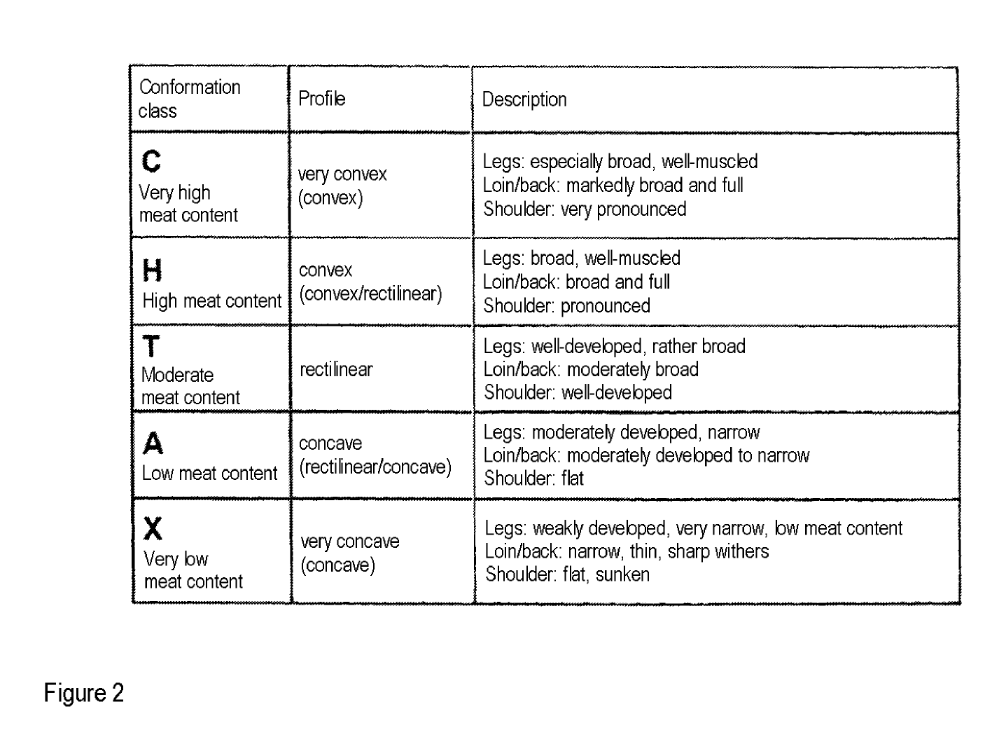

The meat used for the process of the invention can exhibit a conformation between C (very high meat content) and X (very low meat content), as shown in FIGS. 1 and 2. Preference is given to using meat with a conformation between C (very high meat content) and T (moderate meat content).

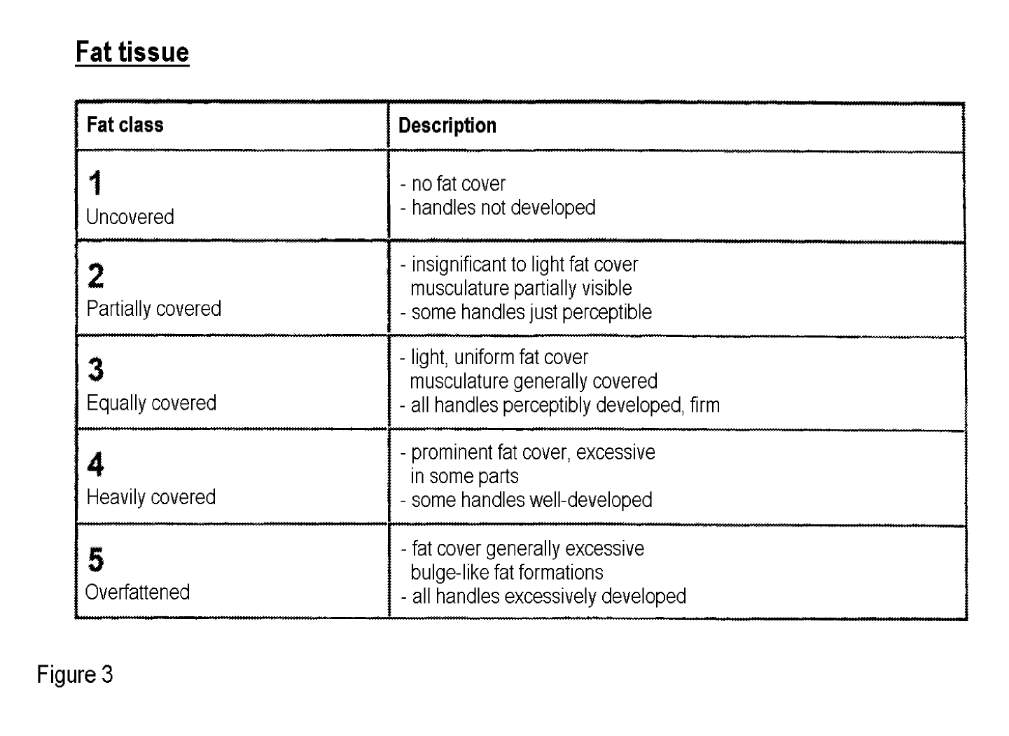

With regard to the fat classes shown in FIG. 3, preference is given to using a meat between class 3 (equally covered) and class 5 (overfattened). By assessing the fat tissue of the carcass (the thickness of the fat layer on the inside of the chest cavity, for example, is a reliable indicator), it is possible to make indirect statements concerning the finishing grade, meat/fat ratios, and marbling of the meat.

For evaluating meat quality, the classifications in terms of conformation and fat content can be combined. Preference is given to using meat between T3 (conformation class T and fat class 3) and C5 (conformation class C and fat class 5).

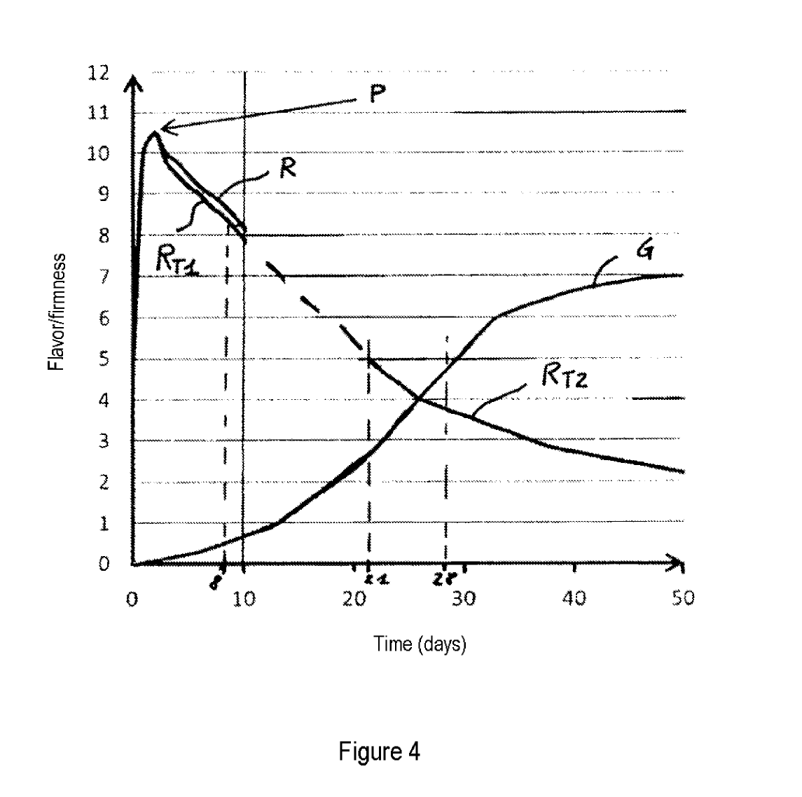

FIG. 4 shows the change of meat firmness and the change of meat flavor over time in a process example. The y-axis shows a scale of 0 to 12 and the x-axis shows a time period of 50 days. The firmness of the meat was subjectively and objectively tested and the result was rated on a scale of 0 to 12, wherein the scale was selected such that the meat is most tender at 0 and toughest at 12. The aging curve R illustrates the change in meat firmness as a function of time with the current standard aging process, i.e., aging in a vacuum bag and an aging period of 10 days maximum. The firmness of the meat increases sharply right after slaughter and attains maximum firmness at the point P around 24 hours after slaughter, after rigor mortis has set in. Afterwards the firmness of the meat diminishes under the action of cellular enzymes and microorganisms. After an aging time T of 10 days maximum, the meat is matured and ready for sale. The aging curve R_{T1} shows the change in meat firmness over time with the prior art “fast aging” method using the mold Thamnidium elegans. From the aging curve R_{T1} it can be seen that after about 8 days the meat has the same firmness as in the aging curve R after 10 days. Use of the mold Thamnidium elegans thus enables a faster meat aging (two days faster in the example shown). Given that bacteria multiply exponentially, this shortening of meat aging by two days is of decisive importance, as it means that meat can also be matured at higher temperatures.

The aging curve R_{T2} shows the change in meat firmness in the range of storage times longer than 21 days. After 21 days the firmness of the meat decreases to a lesser and lesser extent.

FIG. 4 also illustrates the change in the flavor G of the meat over time, wherein the flavor is primarily or exclusively due to the mold Thamnidium elegans. The flavor of the meat was tested subjectively by test persons and the result was rated on a scale from 0 to 12, wherein the scale was selected such that meat with a value of 12 would taste the best. The change in flavor G as a function of time indicates that flavor changes very little during the first 8 to 10 days. The change in flavor G also indicates that after around 40 to 50 days, flavor no longer increases and thus reaches a saturation point. The experiments illustrated in FIG. 4 showed that after 10 days the mold Thamnidium elegans had only permeated a surface layer of the meat, whereas with storage for 21 or more days, depending on the piece of meat, the meat is homogeneously permeated with the mold and the mold enzymes are also able to exert their biochemical activity on the inside of the meat. With a storage time of at least 21 days, the maximum possible flavor is approximately halfway developed. A storage of between 25 to 45 days or a storage of between 28 to 50 days is especially advantageous. As can be discerned from the change in flavor G, the rate of increase begins to diminish after around 25 to 28 days and the slope of the curve of the change in flavor G levels off. Furthermore, tenderness increases only to a limited extent after 25 to 28 days so that from a cost-returns standpoint it is advantageous to end the aging process of the invention after around 25 to 28 days. In the process of the invention, the firmness of the meat steadily decreases, i.e., the tenderness of the meat steadily increases, over at least 21 days and preferably over at least 25 or 28 days. Furthermore, the flavor imparted by the mold Thamnidium elegans is substantially increased so that after 21 to 28 days an extraordinarily tender, flavorful meat is obtained. An aging period of more than 21 or 28 days results in an additional increase in the tenderness and flavor of the meat, wherein the increase diminishes over time, as can be discerned in FIG. 4, and after around 50 days there is hardly any more increase in terms of flavor and after around 100 days there is hardly any more increase in terms of tenderness.

For an especially tender and flavorful meat, the aging process takes place at a temperature between 2 to 4° C. and at a relative humidity between 85% and 98%, preferably between 90% and 98%, in order to inhibit the growth of microorganisms such as bacteria and simultaneously stimulate the growth of the mold Thamnidium elegans. Under these conditions the meat is preferably stored for between 28 to 45 days in order to achieve the tenderness and flavor illustrated in FIG. 4.

1. A process for upgrading fresh meat wherein the mold Thamnidium elegans is added during the aging of the meat, wherein the meat is stored within a temperature range between 0 and 8° C., wherein the meat is stored at a relative humidity between 50% and 98%, and wherein the meat is stored for between 21 and 100 days.

2. The process in accordance with claim 1, wherein the meat is stored for between 28 and 100 days.

3. The process in accordance with claim 1, wherein the meat is stored at a relative humidity between 50% and 95%.

4. The process in accordance with claim 1, wherein the mold Thamnidium elegans is applied to the surface of the meat at a spore density of at least 10⁹ spores per cm², preferably at a spore density between 10¹² spores per cm² and 10¹⁵ spores per cm².

5. The process in accordance with claim 1, wherein the meat is stored within a temperature range between 1 and 5° C., and preferably within a temperature range between 2 and 4° C.

6. The process in accordance with claim 1, wherein the meat is stored at a relative humidity between 75% and 98%.

7. The process in accordance with claim 1, wherein the meat is stored for between 28 and 50 days.

8. The process in accordance with claim 1, wherein the meat is stored within a temperature range between 1 and 5° C., at a relative humidity between 75% and 95%, and for between 25 and 45 days.

9. The process in accordance with claim 1, wherein the meat is stored at a temperature between 2 and 4° C., at a relative humidity between 85% and 98%, preferably between 90% and 98%, and for between 28 and 45 days.

10. The process in accordance with claim 1, wherein meat of conformation classes C (very high meat content) to X (very low meat content) is used.

11. The process in accordance with claim 10, wherein meat of conformation classes T (moderate meat content) to X (very low meat content) is used.

12. The process in accordance with claim 1, wherein meat of fat classes 3 (equally covered) to 5 (overfattened) is used.

13. The process in accordance with claim 1, wherein meat of classes T3 (moderate meat content, equally covered) to C5 (very high meat content, overfattened) is used.

14. The process in accordance with claim 1, wherein veal, beef, lamb, horsemeat, or pork is used as meat.

15. A use of the mold Thamnidium elegans for maturing meat within a temperature range between 2 and 4° C., at an air humidity between 90 and 98%, and for a period of 21 to 100 days, preferably of 28 to 100 days.
